(19) United States
(12) Patent Application Publication
(10) Pub. No.: US 2019/0106911 A1
(43) Pub. Date: Apr. 11, 2019

(54) LATCH DEVICE FOR VEHICLE

(71) Applicant: HONDA MOTOR CO., LTD., Tokyo (JP)

(72) Inventors: Mitsunori NISHINO, Wako-shi (JP); Nobuyuki KISHIKAWA, Wako-shi (JP)

(21) Appl. No.: 16/153,985

(22) Filed: Oct. 8, 2018

(30) Foreign Application Priority Data
Oct. 10, 2017 (JP) 2017-196747

(51) Int. Cl. E05B 77/36; E05B 79/08; E05B 85/26

(52) U.S. Cl. CPC E05B 77/36; E05B 85/26; E05B 79/08

(57) ABSTRACT

A latch device for a vehicle, which is capable of suppressing a butting sound and abnormal noise caused when a closing member is released from the closed position, is provided. The latch device for a vehicle has a driving mechanism to move the ratchet to the engagement-released position after the restraint member is driven in a restrained direction that is a direction to a restrained position from a released position when an operation for releasing a striker is done while the striker is being restrained by engaging the restraint member located at the restrained position with the ratchet located at an engagement position.

### CROSS REFERENCE TO RELATED APPLICATIONS

This application claims the foreign priority benefit under Title 35, United States Code, 119 (a)-(d) of Japanese Patent Application No. 2017-196747 which is filed on Oct. 10, 2017 in the Japan Patent Office, the disclosure of which is herein incorporated by reference in its entirety.

### BACKGROUND OF THE INVENTION

### 1. Technical Field

The present invention relates to a latch device for a vehicle. The latch device locks, unlocks, keeps a perfect closing of and opens a closing member which opens and closes an opening of the vehicle.

### 2. Description of Background Art

Conventionally, a latch device has been used to keep a closed state when an opening of the vehicle is closed with use of a closing member such as a door. For example, a latch device disclosed in the patent document 1 is provided with a striker arranged at the body of a vehicle, a ratchet and a latch arranged at a door. The latch has an approximate U-shape, and is installed so as to be capable of swinging between a released position and a closed position. The ratchet is arranged so as to be capable of engaging with and disengaging from the latch. The striker is inserted in the U-shape groove of the latch, and the ratchet engages with the latch. Thus, the closed state of the opening of the vehicle with use of the closing member is kept. Furthermore, disengaging the ratchet from the latch releases the striker from the latch. Thus the door releases (opens) the opening of the vehicle.

Patent document 1: JP 4444318 B2

### BRIEF SUMMARY OF THE INVENTION

However, in a state that the opening of the vehicle has been closed by a door (closing member), the latch is urged in a direction where the door is opened by a spring force and a reaction force (resilient force) of a seal member held between the periphery defining the opening of the vehicle and the periphery of the door. Thus the latch and the door is urged in such a manner, so that the door is prevented from rattling in the closed state.

Since the latch is received the reaction force in the direction where the door is opened, a repulsive force of the latch in a direction toward the released position becomes large accordingly. Therefore, that brings a result that the latch powerfully turns in the direction toward the released position when the latch is disengaged from the ratchet. In the consequence, there is a fear that the latch strongly butts against the striker or surrounding members, or separates from them to cause butting sound or abnormal noise.

The present invention has been made in view of the foresaid problem. And an object of the present invention is to provide a latch device for a vehicle capable of suppressing butting sound and abnormal noise caused when a closing member is released from the closed position.

In order to achieve the above object, there is provided a latch device for a vehicle of the present invention comprising:

a striker arranged at either one of a vehicle body and a closing member;

a restraint member arranged at the other of the vehicle body and the closing member, and supported so as to be capable of swinging between a restrained position to restrain the striker and a released position to release the striker;

a ratchet supported so as to be capable of moving between an engagement position to engage with the restraint member located at the restrained position and an engagement-released position away from the restraint member located at the restrained position; and

a driving mechanism to move the ratchet to the engagement-released position after the restraint member is driven in a restrained direction that is a direction to the restrained position from the released position when an operation for releasing the striker is done while the striker is being restrained by engaging the restraint member located at the restrained position with the ratchet located at the engagement position.

According to the present invention, a latch device for a vehicle, which is capable of suppressing butting sound and abnormal noise caused when a closing member is released from the closed position, can be provided.

### BRIEF DESCRIPTION OF THE SEVERAL VIEWS OF THE DRAWINGS

Certain preferred embodiments of the present invention will now be described in greater detail by way of example only and with reference to the accompanying drawings, in which:

FIG. 1 is a plan view showing a vehicle provided with a latch device according to an embodiment of the present invention;

FIG. 2 is a schematic view showing a structure of the latch device for a vehicle according to the embodiment;

FIG. 3 is a schematic view showing a restraint member and a ratchet in a state that a door is opened and a striker is released;

FIG. 4 is a schematic view showing the restraint member and the ratchet in a state that the door is perfectly closed against a resilient force of a seal member and the striker is restrained; and

FIG. 5 is a schematic view showing the restraint member and the ratchet in a state that the door is pushed back in a direction where the door is opened from the state shown in FIG. 4 because of the resilient force of the seal member, that is, in a normal state that the door is closed.

### DETAILED DESCRIPTION OF THE INVENTION

An embodiment of the present invention will be described in detail appropriately with reference to the attached drawings. The same symbol is referred to the same element, and duplicated explanation is omitted.

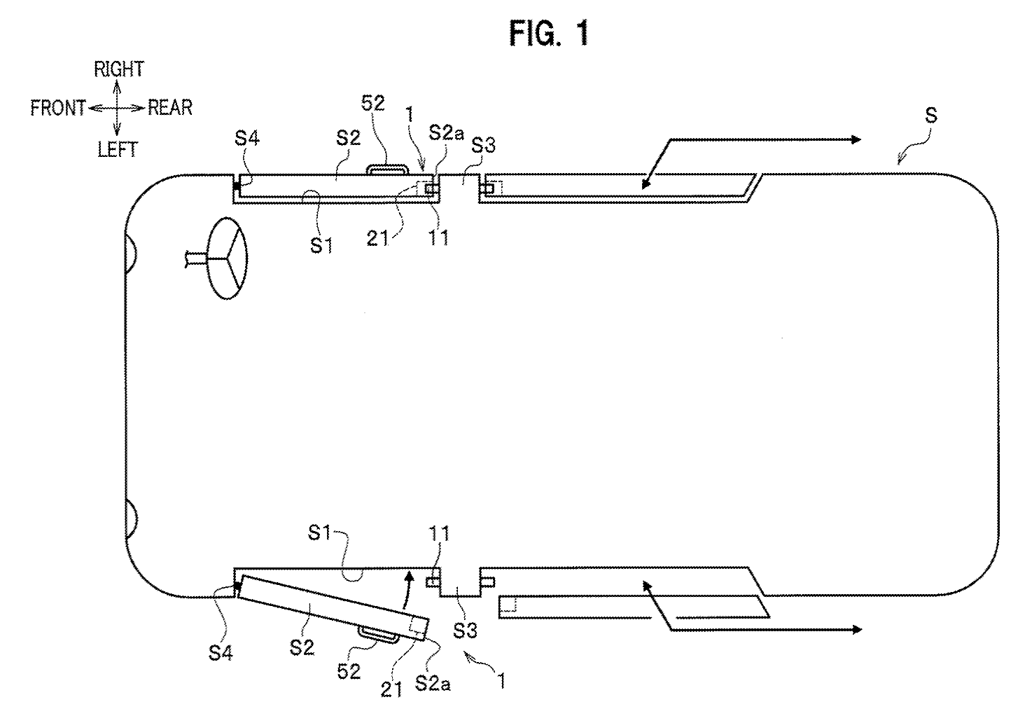

As shown in FIG. 1, a door opening S1 (an opening of a vehicle) is provided in a side surface of a vehicle body S of the vehicle where the latch device 1 for a vehicle of this embodiment is installed. A door (closing member) S2 closes or opens (releases) the door opening S1. The door S2 is supported by the vehicle body S so that the door S2 can swing around a hinge S4 provided at the front end of the door S2. And the door S2 is fitted into the door opening S1 of the vehicle body S to close the door opening S1.

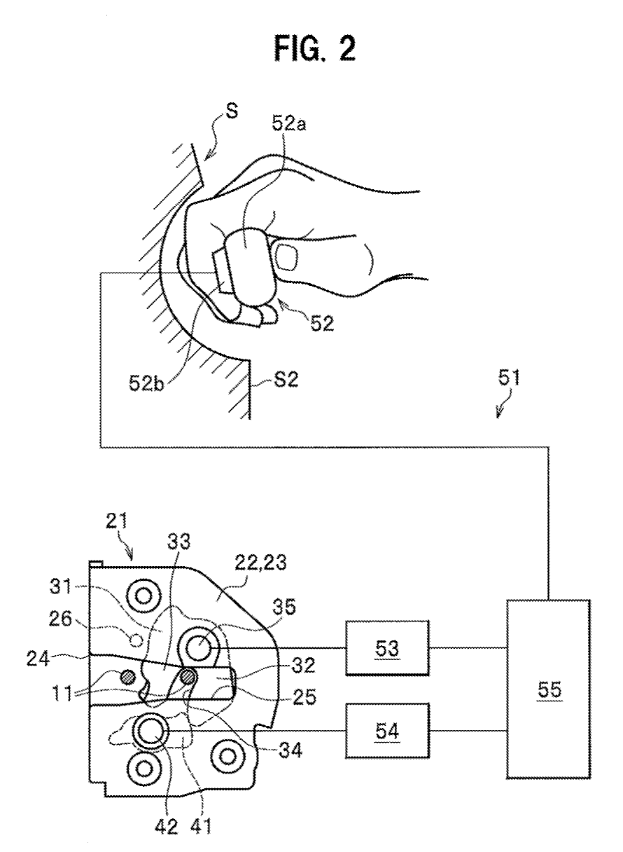

As shown in FIGS. 1, 2, the latch device 1 for a vehicle of this embodiment has a striker 11 arranged on a pillar S3 of the vehicle body S, a latch unit 21 provided at the rear end portion of the door S2 and a driving mechanism 51. When the latch unit 21 restrains the striker 11, the door S2 is kept closed, that is, the state that the door S2 is fitted into the door opening S1 is kept. The striker 11 is formed of a steel member to be a U-shape and projects on the front surface of the pillar S3. A cross section of the steel member is a circle. Furthermore, the striker 11 is arranged on the pillar S3 which partially defines the door opening S1 and is a vertical wall of the vehicle body so that the U-shape of the striker can be seen in a view from the upper side of the vehicle body S.

In the following, the latch unit 21 will be described. As shown in FIG. 2, the latch unit 21 includes a restraint member 31 and a ratchet 41, and the restraint member 31 and the ratchet 41 are unitized by a housing 22. The latch unit 21 is accommodated in an inside of the door S2, and is located at or near a rear end surface S2a of the door S2 facing or opposing to the striker 11. The housing 22 has a pair of thin plate-like brackets 23, and each bracket 23 is arranged so as to face to each other. The housing 22 further has an entry portion 24, a restraint portion 25 and a release abutting member 26.

The entry portion 24 is a portion through which the striker 11 is introduced in the housing 22 when the striker 11 is to be restrained by the latch unit 21. The restraint portion 25 continues with the entry portion 24, and has respective through holes in the pair of brackets 23. And the through holes face to each other. The restraint portion 25 restrains the striker 11 in cooperation with the restraint member 31.

The release abutting member 26 is a projection which stands on one bracket 23 toward the other bracket 23. The restraint member 31 urged in a released direction butts against the release abutting member 26 and is kept at a released position.

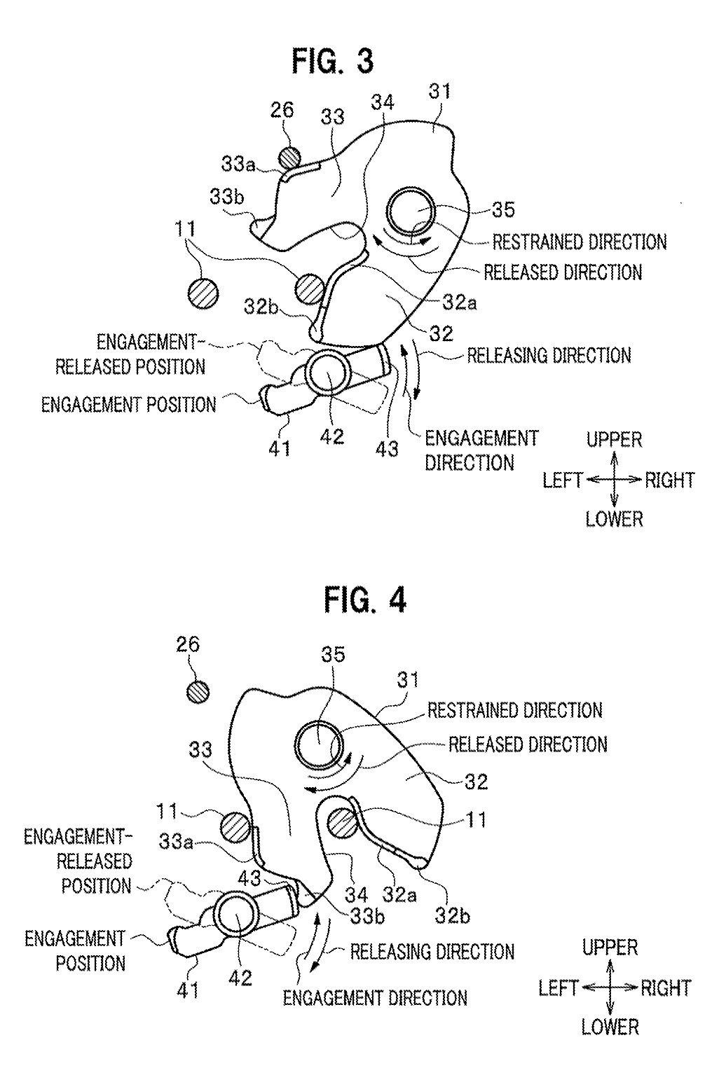

Next, the restraint member 31 will be described. As shown in FIGS. 3, 4, the restraint member 31 is formed of a plate-like member and has an approximate U-shape. The approximate U-shape is formed of a butting arm part 32, a restraint arm part 33 and the other part. The butting arm part 32 and the restraint arm part 33 are opposed to each other. Base end portions of the butting arm part 32 and the restraint arm part 33 are connected through the other part. A recessed part of an approximate U-shape between the butting arm part 32 and the restraint arm part 33 is a restraint groove 34.

The restraint member 31 is arranged in the housing 22 so that the restraint arm part 33 is located on the entry portion 24 side in comparison with the butting arm part 32. Furthermore, the restraint member 31 is arranged between the pair of brackets 23 and supported by a restraint shaft 35 so that the restraint member 31 can swing around the restraint shaft 35 in parallel with plate surfaces of the brackets 23 between the released position and a restrained position. Furthermore, the restraint member 31 is urged in the released direction by the spring force of a release spring (not shown) as release urge means. The restraint shaft 35 is supported by the brackets 23 at both end portions thereof while it passes through a base end portion of the butting arm part 32.

Note that, the released position is a position in which the restraint member 31 releases the striker 11, and the door S2 is in an opened state at the released position (refer to FIG. 3). The restrained position is a position in which the restraint member 31 restrains the striker 11, and the door S2 is in a closed state at the restrained position (refer to FIG. 4). Furthermore, a half restrained position is set between the released position and the restrained position. The half restrained position is a position in which the restraint member 31 temporarily restrains the striker 11, and the door S2 is in a so-called half door state when the striker 11 is temporarily restrained (refer to FIG. 2).

A direction from the restrained position to the released position is named the released direction, and a direction from the released position to the restrained position is named the restrained direction.

An edge part of the butting arm part 32, which edge part is on the restraint groove 34 side and is to butt against the striker 11, is made as an inside cushioning part 32a. A cushioning material is provided to the inside cushioning part 32a. The cushioning material of the inside cushioning part 32a suppresses the generation of butting sound when the butting arm part 32 butts against the striker 11 at the inside cushioning part 32a thereof.

Furthermore, a half restraint engagement part 32b is formed at a tip part on the restraint groove side of the butting arm part 32. The half restraint engagement part 32b is formed so that the shape thereof is satisfied with the following two requirements.

The first requirement is that the half restraint engagement part 32b is configured to engage with a ratchet engagement part 43 of the ratchet 41 located at an engagement position when the restraint member 31 is located at the half restrained position. The second requirement is that the half restraint engagement part 32b is configured to be away from the ratchet engagement part 43 of the ratchet 41 located at an engagement-released position when the restraint member 31 is located at the half restrained position.

The restraint arm part 33 is provided with a release engagement part 33a and a restraint engagement part 33b. The release engagement part 33a is formed on a side part of the restraint arm part 33 opposite to the restraint groove 34, and is configured to be capable of butting against the release abutting member 26 standing on the bracket 23 of the housing 22 when the restraint member 31 is located at the released position. A cushioning material is provided to the release engagement part 33a. The cushioning material suppresses the generation of butting sound when the restraint member 31 butts against the release abutting member 26.

The restraint engagement part 33b is formed at a tip portion of a side part of the restrained arm part 33 opposite to the restraint groove 34, and is configured to be capable of engaging in the released direction with the ratchet engagement part 43 of the ratchet 41 located at the engagement position when the restraint member 31 is located at the restrained position. A cushioning material can be provided to the restraint engagement part 33b. The cushioning material suppresses the generation of butting sound when the ratchet 41 butts against the restraint engagement part 33b. The restraint engagement part 33b has the shape satisfying the following two requirements.

The first requirement is that the restraint engagement part 33b is configured to be capable of engaging with the ratchet engagement part 43 of the ratchet 41 located at the engagement position when the restraint member 31 is located at the restrained position. The second requirement is that the restraint engagement part 33b is configured to be away from the ratchet engagement part 43 of the ratchet 41 located at the engagement-released position when the restraint member 31 is located at the restrained position.

The restraint member 31 formed in the foresaid way is kept to be in the state of butting against the release abutting member 26 because of the spring force of the release spring when the restraint member 31 is located at the released position. When the restraint member 31 is located at the released position, the restraint groove 34 opens along a movement locus where the striker 11 advances into the restraint portion 25 from the entry portion 24. That is, the restraint member 31 releases the striker 11 when the restraint member 31 is located at the released position. Furthermore, when the restraint member 31 is located at the restrained position, the restrained arm part 33 crosses the restraint portion 25 of the brackets 23. Thereby, the striker 11 is restrained within the restraint portion 25, so that the striker 11 is prevented from separating from the latch unit 21. That is, the door S2 is kept closed.

The ratchet 41 will be described in the following. The ratchet 41 is formed of a plate-like member. In this embodiment, the ratchet 41 and the restraint member 31 are arranged so that the restraint portion 25 of the housing 22 is between them in an upper-lower direction in a front-rear view. That is, in this embodiment, the ratchet 41 is located opposite to the restraint member 31 in the upper-lower direction, namely, on the lower side. Furthermore, the ratchet 41 is supported to be capable of swinging around an axis of a ratchet shaft 42 and is provided with the ratchet engagement part 43.

Furthermore, the ratchet 41 is arranged between the pair of brackets 23 of the housing 22, and is supported by the ratchet shaft 42 so that it can swing in parallel with respective surfaces of the brackets 23 between the engagement position and the engagement-released position.

The ratchet 41 is urged in an engaging direction by the spring force of a ratchet spring (not shown) as a device for urging the ratchet. The ratchet shaft 42 passes through the ratchet plate and is supported by the brackets 23 at both ends thereof.

The ratchet engagement part 43 is provided at an end portion on the restraint member 31 side. When the ratchet 41 is located at the engagement position, the ratchet engagement part 43 engages with the restraint member 31 to regulate the movement of the restraint member 31 in the released direction.

The engagement position is a position (refer to solid lines in FIG. 4) that the ratchet 41 engages with the restraint member 31 located at the restrained position or the half restrained position. The engagement-released position is a position that the ratchet 41 is away from the restraint member 31 (refer to a two-dot chain line in FIG. 4).

A direction from the engagement position to the engagement-released position is named a releasing direction, and a direction from the engagement-released position to the engagement position is named the engaging direction.

When the ratchet 41 formed in the foresaid way is located at the engagement position, the ratchet engagement part 43 engages with the restraint engagement part 33b of the restraint member 31 located at the restrained position. Thereby, the ratchet 41 regulates the movement in the released direction of the restraint member 31 being urged in the released direction by the release spring to keep the restraint member 31 at the restrained position.

Furthermore, when the ratchet 41 is located at the engagement position, it engages with the half restraint engagement part 32b of the restraint member 31 located at the half restrained position (refer to FIG. 2). Thereby, the ratchet 41 keeps the restraint member 31 being urged in the released direction by the release spring at the half restrained position to keep the door S2 in the half door state.

Furthermore, when the ratchet 41 is located at the engagement-released position, it is away from the restraint member 31. Thereby, the restraint member 31 becomes to be capable of moving between the restrained position and the released position, and is kept at the released position because of the spring force of the release spring.

Next, the driving mechanism 51 will be described (refer to FIG. 2).

The driving mechanism 51 is a mechanism to release the restrained striker 11 to enable to open the door S2 when an occupant (or a passenger) operates to open the door S2. The driving mechanism 51 has an operation device 52, a restraint member driving device 53, a ratchet driving device 54 and a controller 55.

The operation device 52 has a door handle 52a as an object which the occupant directly operates for the driving mechanism 51 and an operation detective sensor 52b provided to the door handle 52a. Various types of sensors can be adopted as the operation detective sensor 52b. For example, one is a type of sensor for detecting a state that an occupant touches the door handle 52a, another is a type of sensor for detecting a state that an occupant operates the door handle 52a, and another is a type of sensor for detecting a state that an occupant approaches the vehicle.

The restraint member driving device 53 is a device for moving the restraint member 31 in the restrained direction and in the released direction, and has an electric motor and reduction gears. The ratchet driving device 54 is a device for moving the ratchet 41 in the releasing direction, and has an electric motor and reduction gears. Note that, the ratchet 41 is moved in the engaging direction by the spring force of the ratchet spring in the latch device 1 for a vehicle of this embodiment. However, it may be configured to be moved in the engaging direction by the ratchet driving device 54. The controller 55 is a controller for driving and controlling the restraint member driving device 53 and the ratchet driving device 54 based on the detection by the operation detective sensor 52b of the operation device 52, and is constituted by a circuit board such as a CPU, an ECU.

Workings of the latch device 1 for a vehicle having the above structure will be described.

First, when the door S2 is in an opened state, as shown in FIG. 3, the restraint member 31 is kept in a state that the outer surface of the restrained arm part 33 abuts against the release abutting member 26 by the spring force of the release spring to be located at the released position. The restraint arm part 33 of the restraint member 31 located at the released position is away from the movement locus, along which the striker 11 advances into the restraint portion 25 from the entry portion 24, in a direction (upper-lower direction in this embodiment) orthogonal to the movement locus. That is, the restraint arm part 33 is away toward the upper side from the movement locus in this embodiment. The restraint groove 34 opens facing the striker 11 advancing to the entry portion 24, and the inside cushioning part 32a is located in front of the striker 11. Furthermore, the ratchet 41 abuts against the restraint member 31 while it is located at the engagement position by the spring force of the ratchet spring.

Next, when the opened door S2 is closed, as shown in FIG. 4, the striker 11 advances into the restraint portion 25 because of the closing force of the door, and butts against the inside cushioning part 32a to rotate the restraint member 31 in the restrained direction. That is, the striker 11 moves the restraint member 31 to the restrained position from the released position against the spring force of the release spring in the released direction. Furthermore, the ratchet 41 is urged in the engaging direction at the engagement position. Therefore, the restraint member 31 rotates while pushing back the ratchet 41 by the front end portion of the butting arm part 32 and the front end portion of the restraint arm part 33 when the restraint member 31 rotates to the restrained position from the released position.

When the restraint member 31 rotates up to the restrained position, the restraint engagement part 33b and the ratchet engagement part 43 engage with each other, so that the restraint member 31 is kept at the restrained position. Thereby, the striker 11 is held in the restraint portion 25. That is, the door S2 becomes a closed state.

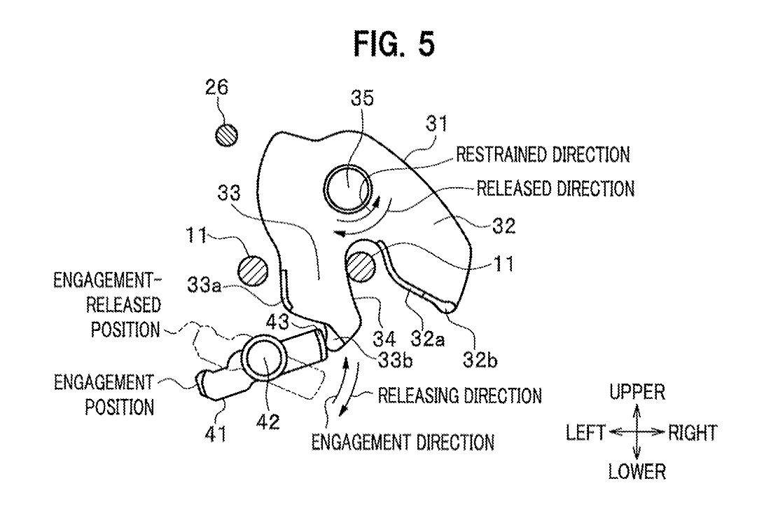

As shown in FIG. 5, when the striker 11 is restrained, that is, when the door S2 is closed, the door S2 is urged in a direction where the door S2 is opened because of the resilient force of the seal member (not shown) held between the periphery of the door S2 and the door opening S1 of the vehicle body S. Thereby, the striker 11 becomes to be restrained by the restraint arm part 33 as shown in FIG. 5, so that the door S2 does not become rickety.

Note that, when the door S2 is closed, the driving mechanism 51 does not become an obstacle for closing the door S2 according to rotational movements of the restraint member 31 and the ratchet 41. The driving mechanism, as another embodiment, can be constituted so that rotational movements of the restraint member 31 and the ratchet 41 are not transmitted to the motors of the restraint member driving device 53 and the ratchet driving device 54 by means of an intermittence structure such as a clutch.

Next, when the closed door S2 is opened, first, an occupant operates the door handle 52a to open the door. At this time, the operation detective sensor 52b detects the operation for the door handle 52a.

The controller 55 controls the restraint member driving device 53 to generate a driving force in the restrained direction upon receiving a detection signal from the operation detective sensor 52b. In the consequence, the engagement between the restraint engagement part 33b of the restraint member 31 and the ratchet engagement part 43 of the ratchet 41 is loosened or disengaged.

Next, the controller 55 controls the ratchet driving device 54 to generate a driving force in the releasing direction. In the consequence, the ratchet 41 is moved to the engagement-released position to leave a movement locus of the restraint member 31. And then, the controller 55 switches the driving force of the restraint member driving device 53 to the released direction from the restrained direction to move the restraint member 31 to the released position.

Note that, the controller 55 controls the ratchet driving device 54 to drive the ratchet 41 from just after it controls the restraint member driving device 53 to drive the restraint member 31 while the restraint member driving device 53 is driving the restraint member 31. That is, while the driving force of the restraint member driving device 53 is acting on the restraint member 31 in the restrained direction, the controller 55 controls the ratchet driving device 54 to move the ratchet 41. Furthermore, after the ratchet 41 is moved to the engagement-released position, the controller 55 gradually changes the strength of the force acting on the restraint member 31 with a change of a direction of the force to the released direction from the restrained direction to move the restraint member 31 to the released position side from the restrained position side while the restraint member 31 is abutting against the striker 11.

In the following, a mode of operation of the latch device 1 for a vehicle according to this embodiment will be described.

This embodiment has the driving mechanism 51 for linking the restraint member 31 and the ratchet 41. When an occupant operates to open the door (to release the striker 11), first, the driving mechanism 51 gives the restraint member 31 a driving force to generate a displacement in the restrained direction. Next, after giving the driving force in the restrained direction, the driving mechanism 51 moves the ratchet 41 to the engagement-released position.

In this way, the linking of the restraint member 31 and the ratchet 41 lowers the resilient force of the seal member acting on the ratchet 41 through the restraint member 31 in a state that the door S2 is closed. Therefore, the pressing force (engagement force) onto the ratchet 41 by the restraint member 31 is lowered when the ratchet 41 leaves the restraint member 31. The pressing force is caused by the rotational force in the released direction of the restraint member 31. The rotational force is caused by the resilient force of the seal member and the spring force of the release spring. In general, the contribution of the resilient force of the seal member to the rotational force is larger. The lowering of the pressing force (engagement force) leads to reduce the generation of a butting sound and noise when the restraint member 31 butts against the release abutting member 26 and the like according to the powerful separation of the ratchet 41 from the restraint member 31.

In this embodiment, the restraint member 31 and the ratchet 41 are driven by the restraint member driving device 53 and the ratchet driving device 54 having respective electric motors. Thereby, the structure around the latch unit 21 is simplified, and the ratchet 41 and the restraint member 31 can be linked with each other.

In this embodiment, the controller 55 controls the ratchet driving device 54 to drive the ratchet 41 just after the controller 55 controls the restraint member driving device 53 to drive the restraint member 31 in the restrained direction. Thereby, the resilient force of the seal member is not input to the ratchet 41 or the resilient force input to the ratchet 41 is lowered. Therefore, the restraint member 31 and the ratchet 41 are prevented from moving in an unexpected mode when the ratchet 41 separates from the restraint member 31. Therefore, butting against surrounding members by the restraint member 31 and the ratchet 41 is lowered, so that the generation of butting sounds and noise can be suppressed.

In this embodiment, the controller 55 controls the ratchet driving device 54 to drive the ratchet 41 while the restraint member driving device 53 is driving the restraint member 31 in the restrained direction. In the consequent, the ratchet 41 moves to the engagement-released position from the engagement position when the ratchet 41 and the restraint member 31 separate from each other. That is, since the regulation by the ratchet 41 is released, the restraint member 31 is suppressed from moving in an unexpected mode due to an extra moving power when the restraint member 31 moves to the released position. Thereby, butting against surrounding members by the restraint member 31 and the ratchet 41 is lowered, so that the generation of butting sounds and noise can be furthermore suppressed.

In this embodiment, the controller 55 controls the restraint member driving device 53 and the ratchet driving device 54 so that the restraint member 31 moves to the released position side from the restrained position side while abutting against the striker 11 after the ratchet 41 moves to the engagement-released position.

On the contrary, in a case where the restraint member 31 is driven in a state of being away from the striker 11, there is a fear that a butting sound is generated when the restraint member 31 again butts against the striker 11.

However, the restraint member 31 moves to the released position from the restrained position while abutting against the striker 11, so that the generation of such a sound can be suppressed.

In this embodiment, the controller 55 controls the restraint member driving device 53 and the ratchet driving device 54 so that after the ratchet 41 moves to the engagement-released position, the strength of the force (this force is the total force of the driving force and the spring force) acting on the restraint member 31 is gradually changed with a change of a direction of the force to the released direction from the restrained direction to move the restraint member 31 to the released position side from the restrained position side. Thereby, since the restraint member 31 moves to the released position side from the restrained position side while abutting against the striker 11, the generation of a butting sound between the restraint member 31 and the striker 11 can be further suppressed.

Note that, the driving mechanism 51 of this embodiment is structured by electric devices such as a sensor, an electric motor, but it is not limited to such a structure. It can be also structured by linking a mechanical element such as a wire, a gear, a cam, a damper to the movement of the door handle 52a. That is, after the restraint member 31 is moved in the restrained direction with linking such a mechanical element, the ratchet 41 is moved in the releasing direction, and the restraint member 31 is moved in the released direction, thereby, the similar mode of operation is attained.

In this embodiment, the restraint member driving device 53 is driven so that the strength of the driving force acting on the restraint member 31 is gradually changed with a change of a direction of the driving force to the released direction from the restrained direction, but the present invention is not limited to such a control way. For example, another control way that the driving force in the restrained direction acting on the restraint member 31 is gradually loosened and the door S2 is opened by the resilient force of the seal member and the spring force of the release spring, can be also adopted.

The latch device 1 for a vehicle of this embodiment is provided with the release spring as well as the restraint member driving device 53, and the release spring always urges the restraint member 31 in the released direction. However, the present invention is not limited to such a structure. For example, the release spring can be omitted and the restraint member driving device 53 can be configured to keep the restraint member 31 at the released position in the state that the door S2 is opened, without the release spring.

In a similar way, the ratchet spring can be omitted and the ratchet driving device 54 can be configured to keep the ratchet 41 at the engagement position.

Furthermore, in this embodiment, the latch device 1 for a vehicle is configured so that the door S2 supported so as to be capable of swinging around the hinge S4 provided at the front end of the door S2, is kept closed, but is not limited to the structure. For example, in a case that the front door and the rear door are opened in a bi-parting state (or a double-swinging state), the front door adopts the foresaid structure, and as for the rear door, a hinge can be provided at the rear end of the rear door, and a latch unit 21 of a latch device 1 for a vehicle can be provided at the front end of the rear door. Furthermore, a latch device 1 for a vehicle according to the present invention can be also adopted to a case that a closing member is a slide door or a trunk lid for a trunk room, and can keep such a closing door closed.

### DESCRIPTION OF REFERENCE NUMERALS

1 Latch device for vehicle

11 Striker

31 Restraint member

41 Ratchet

51 Driving mechanism

52 Operation device

53 Restraint member driving device

54 Ratchet driving device

55 Controller

S Vehicle body

S2 Door (Closing member)

What is claimed is:

1. A latch device for a vehicle, comprising:
a striker arranged at either one of a vehicle body and a closing member;
a restraint member arranged at the other of the vehicle body and the closing member, and supported so as to be capable of swinging between a restrained position to restrain the striker and a released position to release the striker;
a ratchet supported so as to be capable of moving between an engagement position to engage with the restraint member located at the restrained position and an engagement-released position away from the restraint member located at the restrained position; and
a driving mechanism to move the ratchet to the engagement-released position after the restraint member is driven in a restrained direction that is a direction to the restrained position from the released position when an operation for releasing the striker is done while the striker is being restrained by engaging the restraint member located at the restrained position with the ratchet located at the engagement position.

2. The latch device for a vehicle according to claim 1, wherein the driving mechanism comprises:
an operation device by which an operation to open or close the closing member is done;
a restraint member driving device which drives the restraint member in the restrained direction;
a ratchet driving device which moves the ratchet to the engagement-released position from the engagement position: and
a controller which detects the operation to open or close the closing member to drive the restraint member driving device and the ratchet driving device.

3. The latch device for a vehicle according to claim 2, wherein the controller is configured to drive the ratchet in a releasing direction that is a direction toward the engagement-released position from the engagement position through the ratchet driving device just after the restraint member is driven in the restrained direction through the restraint member driving device.

4. The latch device for a vehicle according to claim 2, wherein the controller is configured to drive the ratchet through the ratchet driving device while the restraint member is being driven in the restrained direction through the restraint member driving device.

5. The latch device for a vehicle according to claim 2, wherein the controller is configured to move the restraint member to a side of the released position from a side of the restrained position while the restraint member is abutting against the striker after the ratchet moves to the engagement-released position.

6. The latch device for a vehicle according to claim 3, wherein the controller is configured to move the restraint member to a side of the released position from a side of the restrained position while the restraint member is abutting against the striker after the ratchet moves to the engagement-released position.

7. The latch device for a vehicle according to claim 4, wherein the controller is configured to move the restraint member to a side of the released position from a side of the restrained position while the restraint member is abutting against the striker after the ratchet moves to the engagement-released position.

8. The latch device for a vehicle according to claim 5, wherein the controller is configured to gradually change a strength of a force acting on the restraint member with a change of a direction of the force to the released direction from the restrained direction to move the restraint member to the side of the released position from the side of the restrained position after the ratchet moves to the engagement-released position.

9. The latch device for a vehicle according to claim 6, wherein the controller is configured to gradually change a strength of a force acting on the restraint member with a change of a direction of the force to the released direction from the restrained direction to move the restraint member to the side of the released position from the side of the restrained position after the ratchet moves to the engagement-released position.

10. The latch device for a vehicle according to claim 7, wherein the controller is configured to gradually change a strength of a force acting on the restraint member with a change of a direction of the force to the released direction from the restrained direction to move the restraint member to the side of the released position from the side of the restrained position after the ratchet moves to the engagement-released position.
